(19) United States
(12) Patent Application Publication
(10) Pub. No.: US 2026/0054955 A1
(43) Pub. Date: Feb. 26, 2026

(54) IMAGE FORMING SYSTEM, METHOD OF CONTROLLING IMAGE FORMING SYSTEM, AND STORAGE MEDIUM

(71) Applicant: CANON KABUSHIKI KAISHA, Tokyo (JP)

(72) Inventor: JUN TANAKA, Ibaraki (JP)

(21) Appl. No.: 19/303,926

(22) Filed: Aug. 19, 2025

(30) Foreign Application Priority Data
Aug. 20, 2024 (JP) 2024-139188

(51) Int. Cl. B65H 37/04; H04N 1/00

(52) U.S. Cl. CPC B65H 37/04; H04N 1/00639; B65H 2301/4381; B65H 2301/43827; B65H 2801/48

(57) ABSTRACT

Convenience when case binding operation is confirmed is to be improved. A method of controlling an image forming system configured to perform case binding includes receiving a number of sheets on which a test print pattern image is to be printed, receiving a print instruction to print the test print pattern image, and performing control to perform printing based on the print instruction, wherein, in a case where execution of predetermined postprocessing different from the case binding is set and the print instruction is received, the control is performed to print the pattern image on the received number of sheets, and in a case where execution of the case binding is set and the print instruction is received, the control is performed to print the pattern image on a number of sheets greater by a predetermined number of sheets than the received number of sheets.

### BACKGROUND

### Field of the Technology

The disclosure relates to an image forming system, a method of controlling the image forming system, and a storage medium.

### Description of the Related Art

In a printing apparatus that forms an image on a sheet, a function for confirming whether operation for forming the image on the sheet is normally performed (hereinafter, referred to as “test print function”) is generally used. The test print function is used to perform operation for printing an adjustment image on the sheet in a function of adjusting image formation on the sheet, and is also used to confirm operation of a finishing apparatus that performs finishing on a printed document. For case binding, in addition to the image forming operation, operation for wrapping a body with a cover and gluing a spine is performed. Japanese Patent Application Laid-Open No. 2008-117285 discusses a technique for facilitating case binding printing by storing binding print data including a cover and a body in a storage device of a printing machine in association with an identifier, and reading out the binding print data with the identifier.

However, to confirm the operation of the case binding by using the test print function, it is necessary to separately prepare body data because a certain number of sheets are necessary for gluing the spine of the body, which takes time and effort.

### SUMMARY

According to an aspect of the embodiments, an image forming system configured to perform case binding, in which a bundle of printed sheets as a body is bound by being wrapped with a cover, includes a first reception unit configured to receive a number of sheets on which a test print pattern image is to be printed, a second reception unit configured to receive a print instruction to print the test print pattern image, and a control unit configured to perform control to perform printing based on the print instruction, wherein, in a case where execution of predetermined postprocessing different from the case binding is set and the second reception unit receives the print instruction, the control unit performs control to print the pattern image on the number of sheets received by the first reception unit, and in a case where execution of the case binding is set and the second reception unit receives the print instruction, the control unit performs control to print the pattern image on a number of sheets greater by a predetermined number of sheets than the number of sheets received by the first reception unit.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating case binding.

FIG. 2 is a diagram illustrating an appearance of an image forming system.

FIG. 3 is a block diagram illustrating a hardware configuration of the image forming system.

FIG. 4 is a block diagram illustrating a functional configuration of the image forming system.

FIGS. 5A and 5B are diagrams each illustrating a display example of a service mode screen.

FIG. 6 is a diagram illustrating examples of test charts.

FIG. 7 is a flowchart illustrating processing performed by an image forming apparatus.

### DESCRIPTION OF THE EMBODIMENTS

An exemplary embodiment is described with reference to the drawings.

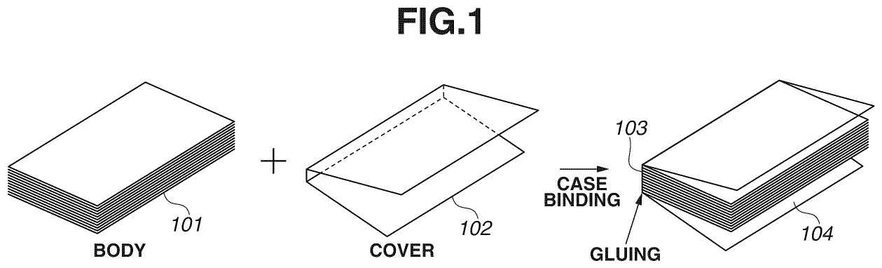

Case binding is described. The case binding is binding in which a spine of a body is glued and the body is wrapped with a cover. FIG. 1 is a diagram illustrating the case binding. A body 101 is a body of the case binding and is a bundle of sheets on which images are printed. A cover 102 is a cover of the case binding and is folded at a center of a long side. A spine 103 of the body 101 is glued and bound to a folded portion of the cover 102. The body 101 is bound in such a manner that a product 104 is obtained. The product 104 is a final product of the case binding.

After the body 101 is bound, a part of the sheets is cut in order to improve appearance in some cases.

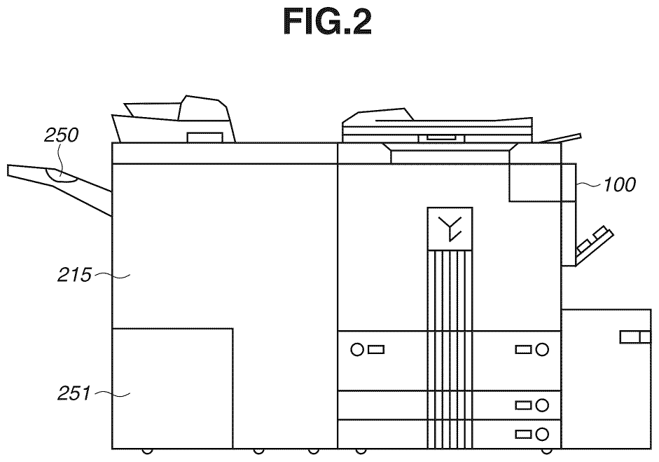

FIG. 2 illustrates appearance of an image forming system according to the exemplary embodiment. In the exemplary embodiment, the image forming system includes a multifunctional peripheral (MFP) 100, and a case binding machine 215 that is a finishing apparatus for finishing sheets printed by the MFP 100. The MFP 100 includes a copy function and a print function. The MFP 100 includes a function of case binding processing. The MFP 100 is an example of an image forming apparatus. As illustrated in FIG. 2, the MFP 100 and the case binding machine 215 are connected to each other.

The sheets printed by the MFP 100 are conveyed to the case binding machine 215. The case binding machine 215 performs case binding operation on the conveyed sheets to create a product of the case binding. A discharge tray 250 is a discharge tray to which a printed document not subjected to the case binding processing is discharged. A sheet that is conveyed to the case binding machine 215 but cannot be subjected to the case binding processing is also discharged to the discharge tray 250. A discharge tray 251 is a discharge tray to which the product of the case binding is discharged.

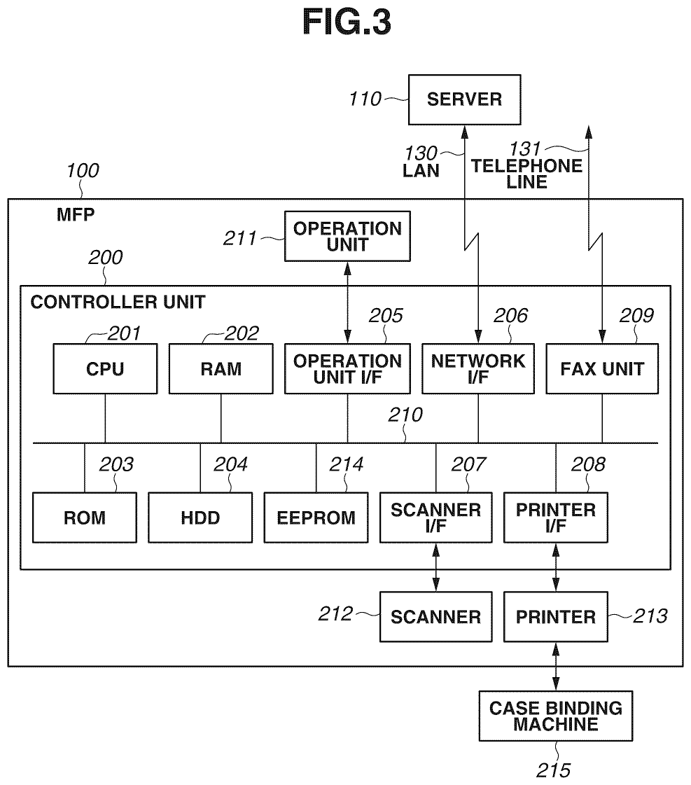

FIG. 3 illustrates a hardware configuration of the image forming system according to the exemplary embodiment. In the image forming system illustrated in FIG. 3, the MFP 100 is connected to the case binding machine 215. The MFP 100 is connected to a server 110 through a local area network (LAN) 130. The MFP 100 includes a controller unit 200, an operation unit 211, a scanner 212, and a printer 213. The controller unit 200 includes a central processing unit (CPU) 201, a random access memory (RAM) 202, a read only memory (ROM) 203, a hard disk drive (HDD) 204, an operation unit interface (I/F) 205, a network I/F 206, a scanner I/F 207, a printer I/F 208, a facsimile (FAX) unit 209, and an electrically erasable programmable read only memory (EEPROM) 214.

These units are connected through a bus 210.

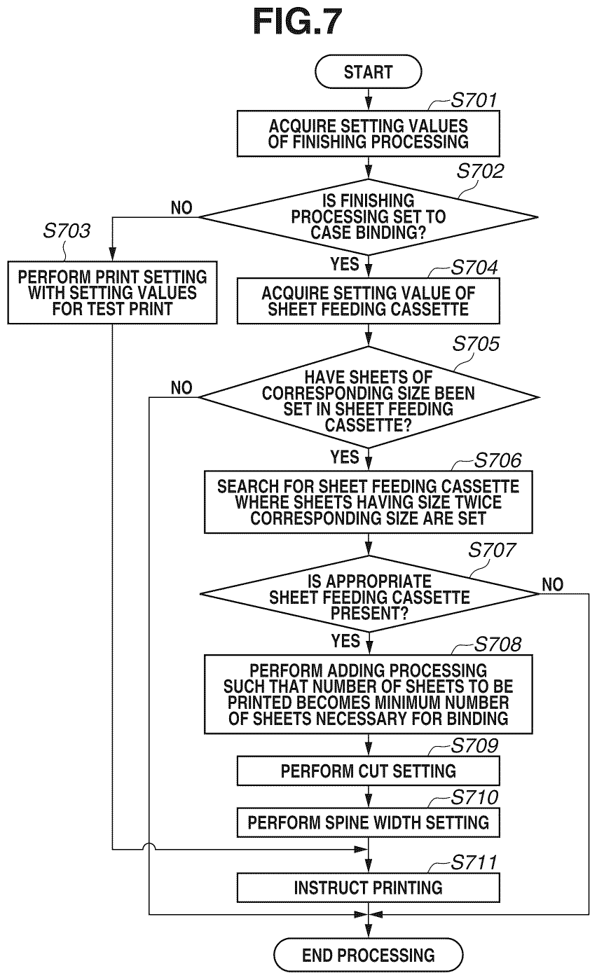

The CPU 201 controls each of the units included in the image forming system. The CPU 201 starts up the MFP 100 based on a boot program stored in the ROM 203. When the CPU 201 reads out various kinds of programs stored in the HDD 204 and performs various kinds of processing by using the RAM 202 as a work area, processing in a flowchart illustrated in FIG. 7 is realized. The HDD 204 stores various kinds of programs including various kinds of function applications for the copy function, the print function, the function of case binding processing, and the like. The HDD 204 stores various kinds of image data such as image data read by the scanner 212.

The operation unit I/F 205 is connected to the operation unit 211, and inputs/outputs data to/from the operation unit 211 under the control of the CPU 201. The operation unit 211 includes an input device such as a touch panel and hardware keys, and a display device such as a liquid crystal display (LCD) and a light-emitting diode (LED). The hardware keys include a start button for instructing scanning start of a set paper document, and the like. The operation unit 211 receives input operation from a user and a service engineer who is a provider of the MFP 100, outputs operation information to the operation unit I/F 205, and displays various kinds of user interface (UI) screens input from the operation unit I/F 205. In the exemplary embodiment, a UI screen displayed for operation in a service mode used by the service engineer is referred to as a service mode screen.

The network I/F 206 is an interface for establishing connection with external apparatuses including the server 110 through the LAN 130. The CPU 201 performs transmission/reception of data with the external apparatuses including the server 110 by using the network I/F 206. A part of the processing performed by the CPU 201 may be performed by the server 110. The FAX unit 209 is an interface for establishing connection with an external FAX apparatus through a telephone line 131. The CPU 201 performs transmission/reception of FAX data with the external FAX apparatus by using the FAX unit 209.

The scanner I/F 207 is connected to the scanner 212. The scanner 212 includes an optical reading unit such as a charge coupled device (CCD), performs optical scanning on the paper document to read the paper document as electronic image data, and outputs the electronic image data to the scanner I/F 207. The scanner 212 causes an automatic document feeder (ADF) to automatically feed a bundle of paper documents placed on a document tray to the optical reading unit one document by one document, and discharges the paper documents after reading. The image data read by the scanner 212 is stored in the HDD 204 through the scanner I/F 207.

The printer I/F 208 is connected to the printer 213. The printer 213 forms an image on a recording medium such as a sheet by using image data input through the printer I/F 208. The printer 213 is connected to the case binding machine 215. The CPU 201 performs, in response to a print execution start instruction, print processing by inputting image data to the printer I/F 208 and causing the printer 213 to perform image forming operation. The CPU 201 performs, in response to a copy execution start instruction, copy processing by inputting image data that is obtained by reading a paper document by the scanner 212 and output from the scanner I/F 207, to the printer I/F 208 and causing the printer 213 to perform image forming operation. The CPU 201 performs, in response to a case binding processing execution instruction, case binding processing by conveying the sheets printed by the printer 213 to the case binding machine 215 and causing the case binding machine 215 to perform case binding operation.

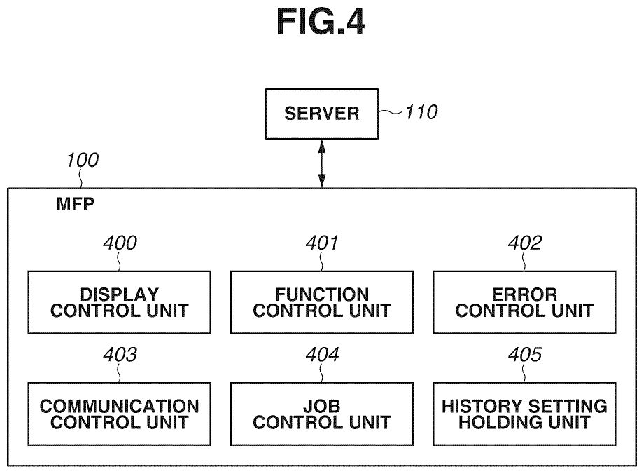

FIG. 4 illustrates a functional configuration example of the image forming system according to the exemplary embodiment. When the CPU 201 executes various kinds of programs stored in the HDD 204 and the like, the MFP 100 functions as a display control unit 400, a function control unit 401, an error control unit 402, a communication control unit 403, a job control unit 404, and a history setting holding unit 405.

The display control unit 400 controls display contents of a UI screen displayed on the operation unit 211 based on the operation information received through the operation unit I/F 205.

The function control unit 401 performs operation control of the various kinds of function applications. The function applications are software (programs) for operating the copy function, the print function, a finishing processing function including the case binding processing, a test print function, and the like. The plurality of function applications is provided for the respective functions. The finishing processing for finishing the sheets printed by the MFP 100 includes, in addition to the case binding processing, staple processing, punch processing, and saddle stitch binding processing. The function control unit 401 switches the display contents of the UI screen displayed on the operation unit 211 based on a switching instruction from each of the function applications.

The error control unit 402 receives a notification of an abnormal state occurring in the printer 213, the scanner 212, the case binding machine 215, and the like, and performs control to stop the entire system or to instruct degeneracy operation.

The communication control unit 403 controls communication with the external apparatuses including the server 110.

The job control unit 404 controls, in response to job execution instructions from the various kinds of function applications, the scanner 212 and the printer 213 through the scanner I/F 207 and the printer I/F 208, thereby performing scan processing, print processing, and case binding processing.

The history setting holding unit 405 manages operation history and various kinds of settings in the apparatus. The history setting holding unit 405 stores settings of the MFP 100, settings of the various kinds of function applications necessary for execution of the job, and the like, in the HDD 204 and the like. The history setting holding unit 405 stores a user operation history, a job execution result, occurrence of an error, and the like in the HDD 204 and the like.

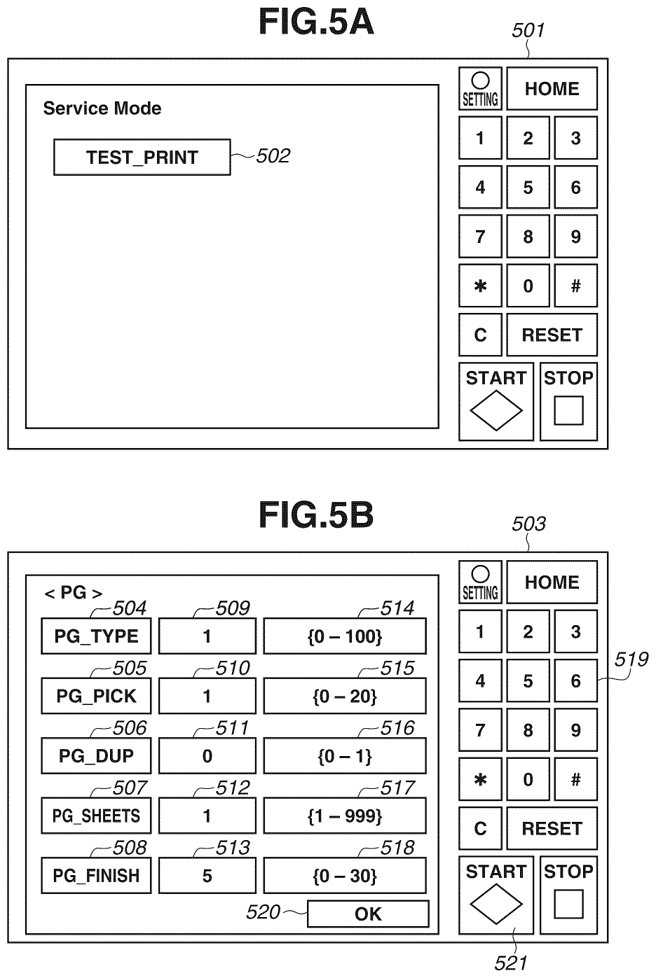

FIGS. 5A and 5B each illustrate a display example of the service mode screen. A menu screen 501 in the service mode illustrated in FIG. 5A is displayed on the operation unit 211 in response to reception of an instruction for switching a mode to the service mode. On the menu screen 501 in the service mode, a TEST_PRINT button 502 for starting up the test print function that is a function usable by the service engineer is displayed. When the TEST_PRINT button 502 is pressed, the function control unit 401 starts up the test print function, and displays a test print setting screen on the operation unit 211. On a test print setting screen 503 illustrated in FIG. 5B, values currently set to respective setting items of the test print function are displayed so as to be changeable.

Item names 504 to 508 in the test print setting screen 503 correspond to respective setting items of the test print function. As numerical value ranges 514 to 518 in the test print setting screen 503, ranges of values that can be input to setting items of the item names 504 to 508 are displayed. As setting values 509 to 513, values currently set to the respective setting items of the item names 504 to 508 are displayed. When any of the setting values 509 to 513 is pressed, a value set to the corresponding setting item is changeable to a value input by a numeric keypad 519. When an OK button 520 is pressed, setting is fixed to the changed value. The history setting holding unit 405 receives the setting values set in the test print setting screen 503 from the operation unit I/F 205, and stores the setting values as test print setting values in the HDD 204. When a start button 521 is pressed, the function control unit 401 issues a test print instruction to the job control unit 404. When receiving the test print instruction, the job control unit 404 performs printing based on the test print setting values stored in the HDD 204.

The setting value 509 of the item name 504 (PG_TYPE) indicates a pattern number of a chart pattern used for the test print. The setting value 510 of the item name 505 (PG_PICK) indicates a cassette number of a sheet feeding cassette for feeding a sheet used for the test print. The setting value 511 of the item name 506 (PG_DUP) indicates whether duplex printing is performed in the test print. The setting value 511 of “0” indicates non-execution of the duplex printing, and the setting value 511 of “1” indicates execution of the duplex printing. The setting value 512 of the item name 507 (PG_SHEETS) indicates the number of sheets to be printed in the test print. The setting value 513 of the item name 508 (PG_FINISH) indicates presence/absence of finishing processing to be performed on the sheet on which the chart pattern is printed, and a type of the finishing processing. The setting value 513 of “5” indicates execution of the case binding processing.

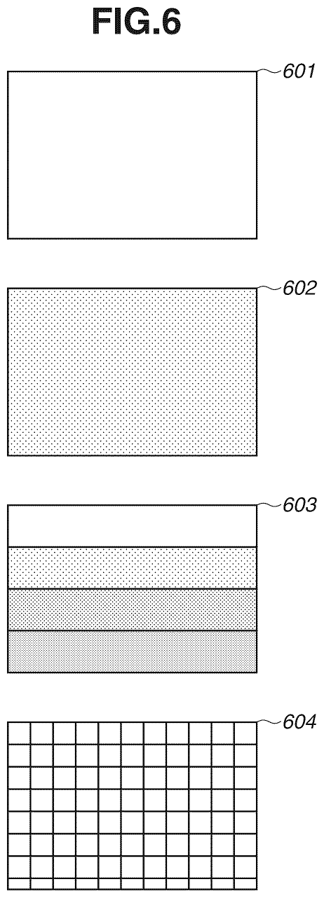

FIG. 6 illustrates examples of the chart pattern for the test print. Chart patterns 601 to 604 illustrated in FIG. 6 are stored in the HDD 204 and the like. Based on the pattern number set in the setting value 509 of the item name 504 (PG_TYPE), any of the chart patterns 601 to 604 illustrated in FIG. 6 is selected. The types of the chart pattern are not limited to the chart patterns 601 to 604 illustrated in FIG. 6. The chart pattern 601 is a white-paper pattern. The chart pattern 602 is a half-tone pattern and has a density between a darkest printable color and a brightest printable color. The chart pattern 603 is a pattern including four divided areas, and the divided areas have different densities. The chart pattern 604 is a lattice pattern.

FIG. 7 is a flowchart illustrating processing performed in a case where the start button 521 is pressed in the test print setting screen 503 that is displayed in the test print function called from the service mode. The flowchart illustrated in FIG. 7 is realized when the CPU 201 reads out the programs stored in the HDD 204 to the RAM 202 and executes the programs.

When the start button 521 is pressed, the CPU 201 reads out the test print setting values stored in the HDD 204.

In step S701, the CPU 201 acquires the setting value (setting value 513) of the setting item (item name 508) of the finishing processing.

In step S702, the CPU 201 determines whether the finishing processing is set to the case binding processing, based on the setting value acquired in step S701. In a case where the finishing processing is set to the case binding processing (YES in step S702), the processing proceeds to step S704. In a case where the finishing processing is not set to the case binding processing (NO in step S702), the processing proceeds to step S703.

In step S703, the CPU 201 performs print setting with the test print setting values.

In step S704, the CPU 201 acquires the setting value (setting value 510) of the setting item (item name 505) of the sheet feeding cassette.

In step S705, the CPU 201 determines whether sheets of a size on which the case binding can be performed have been loaded in the sheet feeding cassette of the set cassette number based on the setting value acquired in step S703. In a case where the sheets of the size on which the case binding can be performed have been loaded (YES in step S705), the processing proceeds to step S706. In a case where the sheets of the size on which the case binding can be performed have not been loaded (NO in step S705), the processing in the flowchart ends.

In step S706, the CPU 201 searches for a sheet feeding cassette in which sheets having a size twice the size of the sheets loaded in the sheet feeding cassette of the set cassette number are loaded. The reason for using sheets having a size twice the size of the sheets loaded in the sheet feeding cassette of the set cassette number as a search criterion is that the sheets loaded in the sheet feeding cassette of the set cassette number are used as the body of the case binding. In a case where the case binding is performed, the cover may be required to have a size twice or more the sheet size for the body in order to wrap the sheets of the body with the cover. In the exemplary embodiment, the sheet feeding cassette in which the sheets of which a length of a short side is equal to a length of the sheets for the body in a direction perpendicular to a conveyance direction and a length of a long side is twice a length of the sheets for the body in the conveyance direction are loaded, is searched for as the sheet feeding cassette for feeding the sheet for the cover.

In step S707, the CPU 201 determines whether the appropriate sheet feeding cassette is present in the search in step S706. In a case where the appropriate sheet feeding cassette is present (YES in step S707), the appropriate sheet feeding cassette is determined to be the sheet feeding cassette for feeding the sheet for the cover, and the processing proceeds to step S708. In a case where the appropriate sheet feeding cassette is absent (NO in step S707), the processing in the flowchart ends.

In step S708, the CPU 201 sets the number of sheets to be printed in the test print. The CPU 201 first acquires the setting value (setting value 512) of the setting item (item name 507) of the number of sheets to be printed. In the case where the case binding is performed, a sufficient number of sheets for the body is necessary for gluing, and therefore, adding processing of the number of sheets is performed. In this example, description is given while the minimum number (predetermined number) of sheets for the body that can be glued and bound by the case binding is 30. For example, the CPU 201 sets a value obtained by adding a value of 29 to the setting value (setting value) 512, as the number of sheets to be printed. In this case, the value of 29 is the number of sheets obtained by subtracting one from the minimum number of sheets that can be bound by the case binding, and is an example of a first predetermined number of sheets. In this way, even when the setting value (setting value 512) is “1” that is the minimum number of sheets settable as the number of sheets to be printed in the test print, it is possible to surely set the number of sheets to be printed greater than or equal to the minimum number of sheets (greater than or equal to predetermined number of sheets) on which the case binding can be performed. For example, in a case where the setting value (setting value 512) is less than “30” (less than predetermined number of sheets), the CPU 201 may change the number of sheets to be printed to 30, and in a case where the setting value (setting value 512) is greater than or equal to “30”, the CPU 201 may not change the number of sheets to be printed. In this case, the value of 30 is the minimum number of sheets on which the case binding can be performed, and is an example of a second predetermined number of sheets.

In step S709, the CPU 201 performs a cut setting of the case binding processing. In the exemplary embodiment, since the setting is to confirm whether the case binding machine 215 is normally operated, a predetermined setting, for example, a cut setting of 2.0 mm is applied. The CPU 201 may change the cut setting based on the size of the sheets for the body and the number of sheets to be printed, or may perform the cut setting with a preset value.

In step S710, the CPU 201 performs a spine width setting of the case binding. As with the cut setting, since the setting is to confirm whether the case binding machine 215 is normally operated, a predetermined setting, for example, a setting in which printing is not performed on a spine portion of the cover is applied. The CPU 201 may change the spine width setting based on the type of the chart pattern.

In step S711, the CPU 201 controls the printer 213 and the case binding machine 215 to perform the case binding processing. The CPU 201 feeds sheets from the sheet feeding cassette of the set cassette number, and prints a pattern image of the set chart pattern. The CPU 201 performs printing on the number of sheets to be printed set in step S708. A bundle of printed sheets is conveyed as the body to the case binding machine 215. The sheet fed from the sheet feeding cassette that is searched for and determined in step S706 is conveyed as the cover to the case binding machine 215. The case binding machine 215 wraps the body conveyed from the MFP 100 with the cover to create a product of the case binding, and discharges the product of the case binding to the discharge tray 251. Thereafter, the processing in the flowchart ends.

According to the exemplary embodiment described above, it is unnecessary to prepare body data and cover data when the test print of the case binding is performed. This makes it possible to improve convenience when the case binding operation is confirmed.

As a modification of the exemplary embodiment, the display contents of the test print setting screen 503 may be controlled based on the fact that the setting value 513 of the item name 508 (PG_FINISH) in the test print setting screen 503 is set to a value (in this example, “5”) indicating execution of the case binding processing. For example, based on the fact that the setting value 513 of the item name 508 (PG_FINISH) is set to “5”, the CPU 201 may change display of the minimum value of the numerical value range 517 of the item name 507 (PG_SHEETS), to the minimum number of sheets on which the case binding can be performed. In a case where the minimum number of sheets on which the case binding can be performed is 30 and a range of [1-999] is displayed as the numerical value range 517, the display of the numerical value range 517 is changed to a range of [30-999]. For example, based on the fact that the setting value 513 of the item name 508 is set to “5”, the CPU 201 may issue a notification prompting a user to input the number of sheets to be printed greater than or equal to the minimum number of sheets (greater than or equal to predetermined number of sheets) on which the case binding can be performed, to the setting value 512 of the item name 507. For example, in a case where the setting value 513 of the item name 508 is set to “5”, and the setting value 512 of the item name 507 is set to a value less than the minimum number of sheets (less than predetermined number of sheets) on which the case binding can be performed, the CPU 201 may automatically change the setting value 512 to the number of sheets to be printed greater than or equal to the minimum number of sheets on which the case binding can be performed.

The exemplary embodiment can be applied to saddle stitch binding. In the saddle stitch binding, printed sheets are piled up and half folded, and a folded part at a center of the sheets is stapled. In a case where the finishing processing is set to the saddle stitch binding processing, the MFP 100 may perform the processing while the minimum number of sheets to be printed is set to two.

The disclosure can be realized by supplying programs realizing one or more functions of the above-described exemplary embodiment to a system or an apparatus through a network or a storage medium, and causing one or more processors in a computer of the system or the apparatus to read out and execute the programs. The disclosure can be realized by a circuit (e.g., application specific integrated circuit (ASIC)) realizing one or more functions.

The above-described exemplary embodiment is merely a specific example for implementing the disclosure, and the technical scope of the disclosure is not limitedly interpreted by the exemplary embodiment. In other words, the disclosure can be implemented in various forms without departing from the technical idea or main features of the disclosure.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-139188, filed Aug. 20, 2024, which is hereby incorporated by reference herein in its entirety.

What is claimed is:

1. An image forming system configured to perform case binding in which a bundle of printed sheets as a body is bound by being wrapped with a cover, the image forming system comprising:
a first reception unit configured to receive a number of sheets on which a test print pattern image is to be printed;
a second reception unit configured to receive a print instruction to print the test print pattern image; and
a control unit configured to perform control to perform printing based on the print instruction,
wherein, in a case where execution of predetermined postprocessing different from the case binding is set and the second reception unit receives the print instruction, the control unit performs control to print the pattern image on the number of sheets received by the first reception unit, and in a case where execution of the case binding is set and the second reception unit receives the print instruction, the control unit performs control to print the pattern image on a number of sheets greater by a predetermined number of sheets than the number of sheets received by the first reception unit.

2. The image forming system according to claim 1, wherein, in the case where execution of the case binding is set and the second reception unit receives the print instruction, the control unit adds the predetermined number of sheets to the number of sheets received by the first reception unit.

3. The image forming system according to claim 1, wherein, in a case where execution of the case binding is set and the number of sheets received by the first reception unit is greater than or equal to another predetermined number of sheets, the control unit does not change the number of sheets received by the first reception unit, and in a case where execution of the case binding is set and the number of sheets received by the first reception unit is less than the other predetermined number of sheets, the control unit changes the number of sheets received by the first reception unit to the other predetermined number of sheets.

4. The image forming system according to claim 1, wherein the control unit performs control to convey a sheet for a body from a sheet holding unit selected by a user, and determines another sheet holding unit for feeding a sheet for a cover based on a size of the sheet loaded in the sheet holding unit selected by the user.

5. The image forming system according to claim 4, wherein the control unit determines, as the sheet holding unit for feeding the sheet for the cover, a sheet holding unit in which a sheet of which a length of a long side is twice a length in a conveyance direction of the sheet loaded in the sheet holding unit selected by the user is loaded.

6. The image forming system according to claim 1, wherein the control unit changes a cut setting of the case binding based on a number of sheets to be printed as the body, or a size of a sheet loaded in a sheet feeding cassette for feeding a sheet for the body.

7. The image forming system according to claim 1, wherein the control unit changes a spine width setting of the case binding based on a type of the test print pattern image.

8. A method of controlling an image forming system, the image forming system configured to perform case binding in which a bundle of printed sheets as a body is bound by being wrapped with a cover, the method comprising:
receiving a number of sheets on which a test print pattern image is to be printed;
receiving a print instruction to print the test print pattern image; and
performing control to perform printing based on the print instruction,
wherein, in a case where execution of predetermined postprocessing different from the case binding is set and the print instruction is received, the performing control is performed to print the pattern image on the received number of sheets, and in a case where execution of the case binding is set and the print instruction is received, the performing control is performed to print the pattern image on a number of sheets greater by a predetermined number of sheets than the received number of sheets.

9. The method according to claim 8, wherein, in the case where execution of the case binding is set and the receiving receives the print instruction, the performing control adds the predetermined number of sheets to the number of sheets received.

10. The method according to claim 8, wherein, in a case where execution of the case binding is set and the number of sheets received is greater than or equal to another predetermined number of sheets, the performing control does not change the number of sheets received, and in a case where execution of the case binding is set and the number of sheets received is less than the other predetermined number of sheets, the performing control changes the number of sheets received to the other predetermined number of sheets.

11. The method according to claim 8, wherein the performing control performs control to convey a sheet for a body from a sheet holding unit selected by a user, and determines another sheet holding unit for feeding a sheet for a cover based on a size of the sheet loaded in the sheet holding unit selected by the user.

12. The method according to claim 11, wherein the performing control determines, as the sheet holding unit for feeding the sheet for the cover, a sheet holding unit in which a sheet of which a length of a long side is twice a length in a conveyance direction of the sheet loaded in the sheet holding unit selected by the user is loaded.

13. The method according to claim 8, wherein the performing control changes a cut setting of the case binding based on a number of sheets to be printed as the body, or a size of a sheet loaded in a sheet feeding cassette for feeding a sheet for the body.

14. The method according to claim 1, wherein the performing control changes a spine width setting of the case binding based on a type of the test print pattern image.

15. A non-transitory computer-readable storage medium that stores a program for causing a computer to perform a method of controlling an image forming system, the image forming system configured to perform case binding in which a bundle of printed sheets as a body is bound by being wrapped with a cover, the method comprising:
receiving a number of sheets on which a test print pattern image is to be printed;
receiving a print instruction to print the test print pattern image; and
performing control to perform printing based on the print instruction,
wherein, in a case where execution of predetermined postprocessing different from the case binding is set and the print instruction is received, the control is performed to print the pattern image on the received number of sheets, and in a case where execution of the case binding is set and the print instruction is received, the control is performed to print the pattern image on a number of sheets greater by a predetermined number of sheets than the received number of sheets.

16. The non-transitory computer-readable storage medium according to claim 15, wherein, in the case where execution of the case binding is set and the receiving receives the print instruction, the performing control adds the predetermined number of sheets to the number of sheets received.

17. The non-transitory computer-readable storage medium according to claim 15, wherein, in a case where execution of the case binding is set and the number of sheets received is greater than or equal to another predetermined number of sheets, the performing control does not change the number of sheets received, and in a case where execution of the case binding is set and the number of sheets received is less than the other predetermined number of sheets, the performing control changes the number of sheets received to the other predetermined number of sheets.

18. The non-transitory computer-readable storage medium according to claim 15, wherein the performing control performs control to convey a sheet for a body from a sheet holding unit selected by a user, and determines another sheet holding unit for feeding a sheet for a cover based on a size of the sheet loaded in the sheet holding unit selected by the user.

19. The non-transitory computer-readable storage medium according to claim 15, wherein the performing control changes a cut setting of the case binding based on a number of sheets to be printed as the body, or a size of a sheet loaded in a sheet feeding cassette for feeding a sheet for the body.

20. The non-transitory computer-readable storage medium according to claim 15, wherein the performing control changes a spine width setting of the case binding based on a type of the test print pattern image.
